(19) United States
(12) Patent Application Publication
(10) Pub. No.: US 2024/0400777 A1
(43) Pub. Date: Dec. 5, 2024

(54) TREATMENT STRATEGIES TO PROTECT AGAINST BLOCKING AND FOULING ASSOCIATED WITH FLOWABLE POLYMER BODIES

(71) Applicant: Ecolab USA Inc., St. Paul, MN (US)

(72) Inventors: Kameswara R. Vyakaranam, Sugar Land, TX (US); Ashish Dhawan, Aurora, IL (US); Omer Gul, Rosenberg, TX (US); Bassam Kamal Alnasleh, Sugar Land, TX (US); Carter M. Silvernail, Lakeville, MN (US)

(21) Appl. No.: 18/676,853

(22) Filed: May 29, 2024

Related U.S. Application Data
(60) Provisional application No. 63/470,077, filed on May 31, 2023.

(51) Int. Cl. C08J 7/06; B29B 9/06; B29B 9/16; B29B 13/06; B29K 25/00; B29K 71/00; C08J 7/04; C09D 7/45; C09D 7/62; C09D 7/63; C09D 183/04

(52) U.S. Cl. CPC C08J 7/065; B29B 9/06; B29B 9/16; B29B 13/065; C08J 7/0427; C09D 7/45; C09D 7/62; C09D 7/63; C09D 183/04; B29K 2025/08; B29K 2071/00; B29K 2071/02

(57) ABSTRACT

Treatment compositions for the treatment of flowable solid polymer bodies and surfaces that come into contact with them comprise a first nonionic surfactant and a second nonionic surfactant. The first nonionic surfactant comprises a plurality of ethylene oxide groups and a plurality of butylene oxide groups. The second nonionic surfactant is different from the first nonionic surfactant and comprises a plurality of ethylene oxide groups. Treatment of flowable solid polymer bodies with the treatment composition may reduce the adhesion of the flowable solid polymer bodies to one another, and treatment of containment surfaces may reduce adhesion of flowable solid polymer bodies thereto. In the manufacture of flowable solid polymer bodies, the treatment composition may be added to the cooling water of a polymer extrusion process to inhibit fouling of surfaces contacted by the cooling water by the bodies. The treatment compositions do not exhibit undue foaming.

### CROSS REFERENCE TO RELATED APPLICATION

This application claims the benefit of U.S. Provisional Patent Application Ser. No. 63/470,077, filed May 31, 2023, the disclosure of which is incorporated in its entirety herein by reference for all purposes.

### TECHNICAL FIELD

The present invention is directed to treatment compositions comprising a combination of surfactants that can be used to treat flowable polymer bodies and/or surfaces in order to help protect against blocking and/or fouling associated with the flowable polymer bodies. When deployed in aqueous media, the treatment compositions if desired are resistant to frothing (also referred to herein as foaming). More particularly, the treatment compositions comprise a first surfactant comprising a plurality of ethylene oxide groups and a plurality of butylene oxide groups, and a second surfactant comprising a plurality of ethylene oxide groups, wherein the first and second surfactants are different from each other. Preferably, the first and second surfactants are nonionic surfactants.

### BACKGROUND

A polymer may be provided in the form of a plurality of solid, flowable bodies such that the polymer bodies are able to flow, be transported, be poured, be fluidized, or otherwise handled in solid form in a way that mimics to a degree how a liquids can be handled. Flowable polymer solids provide several advantages over liquid forms in many contexts. For example, flowable polymer solids are easy to handle at relatively lower temperatures. Flowable solids may be handled at ambient or even colder temperatures, while the same or other polymers if not in the form of flowable bodies may need to be heated to elevated temperatures to be flowable in liquid or molten form. Even if liquid media might be used in the manufacture, transport, packaging, use, and/or the like of flowable polymer solids, the resulting solid, flowable materials may be subsequently used without requiring any solvent or liquid carrier, although some kind of liquid carrier could still be used in some instances if desired. Packing and transport of flowable solids in dry form often can be easier than for liquid media, as is clean up.

Flowable solid polymer bodies may be provided in a variety of physical forms such as powder, pellets, granules, chunks, grains, other particle forms, combinations of these, and the like. Flowable polymer bodies may be provided in a wide range of sizes suitable for the desired end use. For example, flowable polymer bodies in some instances may have sizes ranging from 0.1 microns or greater. Materials that are smaller or even larger than this can be used in other instances. Supplies may be processed, such as by screening or the like, to help limit a particular supply to one or more particular size ranges and/or distributions.

According to an illustrative mode of practice, flowable solid polymer bodies referred to in the plastic industry as polymer pellets are widely used as a source material for fabricating polymer articles. For example, the solid polymer bodies may be held in a hopper or other suitable supply containment and then allowed or caused to flow into an extruder, injection molding apparatus, calendaring apparatus or the like in order to form desired articles, optionally in combination with other ingredients.

Polymer pellets may be produced in a variety of ways, including by an extruder-pelletizer strategy in which an extrudate is subdivided in a manner to form relatively smaller sized, flowable, solid polymer bodies. Examples of extrusion and pelletizing processes include melt pelletizing and strand pelletizing. In melt pelletizing, a hot polymer melt emerging from an extruder die may almost immediately be subdivided into pellet form while still in a molten or partially molten state and then subsequently cooled to form solid, flowable bodies. In strand pelletizing, a strand of polymer melt may be drawn into a cooling water tank and cooled to solid form, whereupon it is then pelletized by a pelletizer. Variations of these methods exist. In an underwater hot-cut method, a molten, thin rod-shaped polymer may be extruded from an extruder, drawn into a water tank, cooled, and then pelletized by a pelletizer. In a water-cooled hot-cut method, molten resin may be extruded and pelletized by cutting under sprayed cooling water.

In the aforementioned methods, aqueous liquid media or other cooling media (e.g., another liquid or a gas) may act as a coolant, cooling the hot extrudate and/or hot pellets sufficiently to provide solid, flowable pellets. When an aqueous liquid medium is used as a coolant, the cooling water and/or pellets are generally subsequently separated. The cooling water having absorbed the heat from the hot polymer material, thus becomes heated itself. In some methods, the cooling water is cooled in a heat exchanger and recirculated to be used to cool more pellet product.

The resulting pellets may be handled or otherwise used in a variety of ways. Often, the pellet product is initially transported to a dryer and/or a storage silo before being deployed for further use in the fabrication of polymer articles or the like.

Several problems may be encountered in the production, processing, and/or handling of flowable polymer bodies such as pellets. For example, in an extrudate-cooling water recirculation system, when pellets are separated from the cooling water, not all of the pellets are separated. Some pellet material, possibly including fines (smaller sized pellets such as those having a diameter in the longest dimension of under 500 microns, or even under 100 microns, or even under 10 microns, or even finer) may continue to be present in the separated cooling water. The remaining polymer bodies circulate with the cooling water and could adhere to and thereby foul containment system surfaces that the cooling water contacts. Such fouling is a type of blocking in which the polymer material has a tendency to unduly adhere to other polymer material and/or other surfaces that contact the polymer material. Pipes and neck-points in the recirculation system may become fouled and even blocked, especially in the heat exchanger. Operations may have to be shut down in order to clean and decontaminate surfaces, clean or replace cooling water, remove blockages, and the like.

Furthermore, the desired polymer pellets even when dried may block with each other or foul surfaces, that is show undue adhesion among pellets, with surfaces and/or friction that may prevent or otherwise impair the movement of the surface of a pellet against another surface such as the contacting surface of an adjacent pellet or the contacting surface of a containment. Such blocking and fouling may occur during any pellet handling and processing, such as during pelletizing, drying, storing, transporting, fluidizing, packing, and molding. Blocking and fouling may become worse when the pellets are at increasingly higher temperatures. Blocking and fouling are encountered particularly frequently in containments such as conveyors, piping, silos, and the like where inter-pellet blocking and pellet-containment surface adhesion can result in pellets not flowing freely or even being unduly difficult to remove from the containment. There is a strong need to protect flowable polymer materials against undue blocking and fouling.

Treatments are available for addition to cooling water that contacts the pellets in order to alleviate blocking and fouling problems. For example combinations of a lubricant and an emulsifying surfactant such as a nonionic surfactant may be added to cooling water to address blocking and fouling. However, some treatments utilizing surfactants may produce too much frothing when added to aqueous cooling liquids.

One example of a successful commercial practice has used combinations of polysiloxane and polysiloxane-modified silica sols to prevent or reduce blocking and other problems with flowable polymer bodies such as polymer pellets. The combinations not only reduce blocking but also are relatively low-foaming. Such treatment compositions have been added to, for example, cooling water in extrusion-pelletization processes, wherein the treatment compositions may dissolve or otherwise disperse in the cooling water. The treated cooling water contacts the pellets, and when the pellets are separated from the cooling water and subsequently dried, components of the treatment composition may coat at least a portion of the surface of the pellets to provide a surface treatment that alleviates blocking and fouling. Consequently, pellets treated with polysiloxane-containing materials may have polysiloxane-containing materials located on the pellet surface to provide this surface effect.

It would be desirable to use less expensive alternative materials to replace some or even all of the polysiloxane materials used in these surface treatments. Unfortunately, it is difficult to formulate alternative surface treatments with less expensive, easier to source materials that are able to sufficiently mimic or even exceed the ability of polysiloxane materials to protect against blocking and fouling without causing undue frothing, particularly in aqueous cooling media. In particular, some materials that protect against blocking and fouling may tend to cause excessive frothing. Other materials froth less but do not provide enough protection against blocking and fouling.

Accordingly, it would be an advantage if treatments were available to reduce or eliminate the aforementioned problems associated with flowable polymer bodies such as in the context of polymer pellet handling, storage, production, transport, and processing, that could generate relatively low amounts of foam and were available to be used in combination with or as an alternative to polysiloxane-containing materials.

### SUMMARY

The present invention provides strategies that use ingredients comprising a combination of nonionic surfactants to reduce blocking, frothing (i.e., foaming) in aqueous media if desired, and fouling problems associated with flowable solid polymer bodies such as powders, granules, grains, pellets, chunks, particles, combinations of these and the like. The strategies can be used to treat polymer surfaces and/or other surfaces that contact the polymer surfaces. Advantages of the combination of nonionic surfactants may include reduction of blocking, frothing, and fouling, and these advantages may be realized with materials that are less expensive and easier to source than current polysiloxane-based materials. This allows the combination of nonionic surfactants of the present invention to be substituted for some or even all of the polysiloxane-based materials used in conventional treatments.

In an illustrative mode of practice, treatment compositions of the present invention may be used to treat polymer pellets to provide treated pellets. Advantageously, in some aspects of this practice, the treatment materials can be incorporated into treatment compositions in the form of aqueous cooling media used in the fabrication of solid, flowable polymer pellets from extruded source polymer material. In these aspects, the source polymer material and/or resultant pellets derived from the polymer material both are cooled as well as treated with the same aqueous media. In the practice of the present invention, this cooling and treatment occurs if desired with relatively low tendency for the aqueous media to froth as might occur in the presence of other surfactant(s).

After contact with an aqueous treatment composition of the present invention followed by drying, the treated polymer pellets tend to be coated or otherwise surface treated with the combination of nonionic surfactants incorporated into the aqueous media. As a consequence, the treated pellets exhibit a lower tendency to block and/or cause equipment fouling than like pellets that have not been treated. For example, the adhesion of a treated pellet to another pellet and/or adhesion and associated fouling of equipment surfaces may be reduced. This helps to protect the flowability characteristics of the solid, polymer bodies such as polymer pellets, making the pellets easier to transport, pour, dispense, package, use, or otherwise handle.

When in the form of aqueous cooling media, such as recirculating aqueous cooling media in a system in which polymer pellets are derived from extruded polymer material, the treatment compositions of the present invention may decrease fouling of surfaces that are contacted by treated, waterborne polymer solid bodies, for example waterborne pellets or corresponding fines that are entrained or otherwise dispersed in the cooling media as the cooling media circulates.

The relatively diluted treatment compositions in the form of aqueous cooling media, sprays for treating surfaces, and the like, optionally may be derived from one or more concentrated embodiments of the treatment compositions or treatment composition precursors that may or may not include a liquid carrier such as an aqueous liquid carrier. A precursor composition refers to a composition that does not include both the first and second nonionic surfactants described herein. A precursor composition may include only one of these nonionic surfactants or neither of these nonionic surfactants. Precursor compositions may be combined with each other and optionally one or more other materials (e.g., additional liquid carrier, other additives, and the like) to form relatively concentrated embodiments of the treatment compositions that subsequently are diluted to form a relatively diluted embodiment that is used to carry out a treatment of polymer material or other surfaces. Alternatively, the precursor compositions and optionally one or more other materials may be combined to directly form the treatment compositions to be used to carry out a treatment without first proceeding through a more concentrated form.

Further, the treatment compositions may be used to protect surfaces against fouling associated with flowable, solid polymer bodies such as the treated, flowable solid polymer bodies of the present invention; flowable, solid polymer bodies treated in other ways; and/or untreated, solid, flowable polymer bodies. A surface treatment of the present invention generally is accomplished by contacting and at least partially coating a surface with a treatment composition of the present invention and then drying or otherwise curing the coating in a manner effective to cause the surface to be more resistant to fouling than an untreated surface. The treatment compositions impart antifouling properties to the surfaces on which the compositions are applied and dried or otherwise cured (e.g., compositions may be ultraviolet curable or the like). The surface treatment may be accomplished in a variety of ways such as by brushing, pouring, spraying, wiping, rolling, laminating, or otherwise applying the treatment composition onto the surface to be protected against fouling and then allowing or causing the surface to dry, optionally with heating although coating and/or drying may occur under ambient conditions or even chilled conditions.

In illustrative modes of practice, in addition to or as an alternative to treating polymer bodies themselves, treatment compositions of the present invention may be used to treat a wide range of surfaces that contact flowable, solid polymer bodies such as extruders, pelletizers, separators, piping, pumps, conveyors, heaters, chillers, containments, and the like. For example, the treatment compositions of the present invention may be added to the spray water used to spray down at least a portion of the interior surfaces of a silo prior to storing flowable, solid polymer pellets in the silo. After application of a treatment composition to one or more interior surfaces of a silo and drying or other curing thereof, the treated interior surfaces show reduced fouling and/or adhesion to polymer pellets contained by the silo and in contact with the pellets. Protection against fouling is further enhanced in those modes of practice in which the flowable polymer bodies also are surface treated in a manner to protect against blocking. Preferably, a surface treatment of the present invention is used on both the polymer material and at least a portion of the surface(s) that contact the polymer material.

In general, many conventional, surfactant-containing, aqueous compositions may be particularly prone to undesired foaming. Foaming of surfactant-containing compositions is undesirable in many instances, because foaming may provide difficulties in handling of the surfactant-containing compositions. For example, the compositions may entrain air and occupy undue space in pipes and/or storage vessels. Foamed compositions may be difficult to pump because of the entrained air. Further, foamed compositions may provide reduced contact between flowable polymer bodies and surfactant and less protection against fouling and/or blocking of the polymer bodies. Because the treatments of the present invention have improved resistance to foaming, they are particularly well-suited for use in aqueous media such as in aqueous spray applications for surfaces to impart anti-fouling properties thereto. Further, foaming may be a severe problem in prior-art treatment compositions added to aqueous cooling media in polymer extrusion processes, for example during cooling of extruded polymer material and/or pellets derived therefrom, centrifugal separation of recirculated, aqueous cooling media, combinations of these, and the like. Accordingly, the treatment compositions described herein are also particularly well-suited for addition to cooling water in extrusion and other aqueous media used in the fabrication, processing, or other handling of flowable, solid, polymer bodies.

In an embodiment, a method of treating a plurality of polymer pellets comprises contacting the polymer pellets with a treatment composition, wherein the treatment composition comprises i) an aqueous liquid carrier, ii) a first nonionic surfactant comprising a plurality of ethylene oxide groups and a plurality of butylene oxide groups, and iii) a second nonionic surfactant comprising a plurality of ethylene oxide groups, wherein the first and second nonionic surfactants are chemically different from each other.

In an embodiment, a method of treating a containment defining an interior volume comprises contacting an interior surface of the containment with a treatment composition in a manner effective to provide a treated containment having a treated interior surface, wherein the treatment composition comprises i) an aqueous liquid carrier, ii) a first nonionic surfactant comprising a plurality of ethylene oxide groups and a plurality of butylene oxide groups, and iii) a second nonionic surfactant comprising a plurality of ethylene oxide groups, wherein the first and second nonionic surfactants are chemically different from each other.

In an embodiment, a method of extruding a polymer comprises (a) melt-extruding a polymer to form an extrudate; and (b) contacting the extrudate with a cooling composition, wherein the cooling composition comprises i) an aqueous liquid carrier, ii) a first nonionic surfactant comprising a plurality of ethylene oxide groups and a plurality of butylene oxide groups, and iii) a second nonionic surfactant comprising a plurality of ethylene oxide groups, wherein the first and second nonionic surfactants are different from each other.

In an embodiment, a treatment composition comprises a) a first nonionic surfactant comprising a plurality of ethylene oxide groups and a plurality of butylene oxide groups, and b) a second nonionic surfactant comprising a plurality of ethylene oxide groups, wherein the first and second nonionic surfactants are different from each other.

In an embodiment, an aqueous treatment composition comprises a) a first nonionic surfactant comprising a plurality of ethylene oxide groups and a plurality of butylene oxide groups; b) a second nonionic surfactant comprising a plurality of ethylene oxide groups, wherein the first and second nonionic surfactants are different from each other; and c) an aqueous carrier liquid.

In an embodiment, a plurality of treated polymer pellets includes an outer surface, wherein the outer surface is at least partially coated with a treatment, the treatment comprising a) a first nonionic surfactant comprising a plurality of ethylene oxide groups and a plurality of butylene oxide groups, and b) a second nonionic surfactant comprising a plurality of ethylene oxide groups, wherein the first and second nonionic surfactants are chemically different from each other.

### BRIEF DESCRIPTION OF THE DRAWINGS

FIG. 1 is a schematic of a method of producing pellets according to embodiments of the invention

FIG. 2 is a bar chart of relative foam amounts as determined in Example 2 set forth herein.

FIG. 3 is a plot of foam height for different compositions tested in Example 3 as set forth herein.

FIG. 4 is a schematic of a method of spraying a surface according to embodiments of the invention.

FIG. 5 is a schematic of a coated surface according to embodiments of the invention.

FIG. 6 shows foam data indicative of antifoam efficiency with respect to compositions tested in Example 4.

### DETAILED DESCRIPTION

Although the present disclosure provides references to various embodiments, persons skilled in the art will recognize that changes may be made in form and detail without departing from the spirit and scope of the application. Various embodiments will be described in detail with reference to the figures. Reference to various embodiments does not limit the scope of the claims attached hereto. Additionally, any examples set forth in this application are illustrative and are not intended to be limiting and merely set forth some of the many possible embodiments for the appended claims.

Unless otherwise defined, all technical and scientific terms used herein have the same meaning as commonly understood by one of ordinary skill in the art. In case of conflict, the present document, including definitions, will control. Methods and materials are described below, although methods and materials similar or equivalent to those described herein can be used in practice or testing of the present application. All publications, patent applications, patents and other references mentioned herein are incorporated by reference in their respective entireties and for all purposes.

As used herein, the terms “comprise(s),” “include(s),” “having,” “has,” “can,” “contain(s),” and variants thereof are intended to be open-ended transitional phrases, terms, or words that do not preclude the possibility of additional acts or structures.

The singular forms “a,” “and” and “the” include plural references unless the context clearly dictates otherwise.

As used herein, the term “optional” or “optionally” means that the described, feature, condition, event or circumstance may but need not occur, and that use thereof includes instances where the event or circumstance occurs and instances in which it does not.

As used herein, any recited ranges of values contemplate all values within the range and are to be construed as support for claims reciting any sub-ranges having endpoints which are real number values within the recited range. By way of example, a disclosure in this specification of a range of from 1 to 5 shall be considered to support claims to any of the following ranges: 1-5; 1-4; 1-3; 1-2; 2-5; 2-4; 2-3; 3-5; 3-4; and 4-5; and fractions thereof e.g. 1.5-3.5, 1.7-4.8, etc.

### Treatment Compositions

A treatment composition of the present invention comprises, consists of, or consists essentially of a) a first nonionic surfactant comprising a plurality of ethylene groups and a plurality of butylene oxide groups; and b) a second nonionic surfactant comprising a plurality of ethylene oxide groups, wherein the first and second nonionic surfactants are different from each other. As further described below, the treatment composition may include one or more optional ingredients if desired. A liquid carrier, preferably an aqueous liquid carrier, is an example of an optional ingredient.

The weight ratio of the first nonionic surfactant to the second nonionic surfactant may be selected within a wide range. In illustrative modes of practice, the weight ratio of the first nonionic surfactant to the second nonionic surfactant in the treatment composition may be about 1:100 to about 100:1, or 1:5 to about 5:1, or about 1:2 to about 4:1, or about 1:2 to about 3:1, or about 1:2 to about 5:2, or about 1:1 to about 5:2, or about 2:1.

The concentration of the first and second nonionic surfactants in the treatment composition may vary over a wide range depending on whether the treatment composition is in the form of a concentrate that is subsequently to be diluted to a final form useful to carry out a treatment or whether the treatment composition is in its final form. Relative to the total amount of liquid carrier, illustrative embodiments of such a treatment composition may comprise 1 ppm to 3000 ppm by weight of the first nonionic surfactant (that is 1 part by weight to 3000 parts by weight of the first nonionic surfactant per one million parts by weight of liquid carrier in the treatment composition), or 5 ppm to 3000 ppm, or 5 ppm to 2500 ppm, or 10 ppm to 3000 ppm, or 100 ppm to 3000 ppm, or 500 ppm to 3000 ppm, or 900 ppm to 2500 ppm, or about 1500 ppm to about 2500 ppm, or about 2000 ppm of the first nonionic surfactant by weight.

Similarly, relative to the total amount of liquid carrier, illustrative embodiments of such a treatment composition may comprise 100 ppm to 5000 ppm by weight of the second nonionic surfactant (that is 100 parts by weight to 5000 parts by weight of the second nonionic surfactant per one million parts by weight of the liquid carrier in the treatment composition), or 200 ppm to 3000 ppm, or 500 ppm to 3000 ppm, or 500 ppm to 2000 ppm, or 500 ppm to 1500 ppm, or 750 ppm to 1500 ppm, or 750 ppm to 1250 ppm, or about 1000 ppm of the second nonionic surfactant by weight.

Treatment compositions of the present invention also may be formulated as concentrates that later are diluted to provide the final concentration of the first and second nonionic surfactants suitable to carry out a treatment. Treatment compositions in concentrate form may include from 0 to 1000 parts by weight, 0 to 500 parts by weight, 0 to 50 parts by weight, 0 to 10 parts by weight, 0 to 5 parts by weight or even 0 to 0.5 parts by weight of liquid carrier per 10 parts by weight of the total amount of the first and second nonionic surfactants in the concentrate.

Alternatively, treatment compositions may be formulated from two or more precursor compositions in which the first and second nonionic surfactants initially are supplied in separate admixtures which later are combined with each other and optionally one or more other ingredients to form treatment compositions of the present invention. Precursor compositions may include one of the first or second nonionic surfactants at a wide range of concentrations, including in concentrated form that is later to be diluted to the final form used to carry out a treatment. In relatively dilute embodiments, the concentration of one of the first or second nonionic surfactants in illustrative embodiments relative to the amount of liquid carrier may be in the range from 100 ppm to 5000 ppm by weight of the second nonionic surfactant (that is 100 parts by weight to 5000 parts by weight of the applicable nonionic surfactant per million parts by weight of the liquid carrier in the treatment composition), or 200 ppm to 3000 ppm, or 500 ppm to 3000 ppm, or 500 ppm to 2000 ppm, or 500 ppm to 1500 ppm, or 750 ppm to 1500 ppm, or 750 ppm to 1250 ppm, or about 1000 ppm of the applicable nonionic surfactant by weight. In more concentrated embodiments, the concentration of one of the first or second nonionic surfactants in illustrative embodiments of a precursor composition may be in the range from 0 to 1000 parts by weight, 0 to 500 parts by weight, 0 to 50 parts by weight, 0 to 10 parts by weight, 0 to 5 parts by weight or even 0 to 0.5 parts by weight of liquid carrier per 10 parts by weight of the total amount of the first and second nonionic surfactants in the concentrate.

### First Nonionic Surfactant

The first nonionic surfactant comprises, consists of, or consists essentially of a plurality of substituted or unsubstituted ethylene oxide (—CR¹R²—CR³R⁴—O—) groups and a plurality of substituted or unsubstituted butylene oxide (—CR⁵R⁶—CR⁷R⁸—CR⁹R¹⁰—CR¹¹R¹²—O—) groups. R¹, R², R³, R⁴, R⁵, R⁶, R⁷, R⁸, R⁹, R¹⁰, R¹¹, and R¹² are individually selected from hydrogen and one or more types of monovalent organic moieties such as hydrocarbyl groups. R¹, R², R³, R⁴, R⁵, R⁶, R⁷, R⁸, R⁹, R¹⁰, R¹¹, and R¹² may be co-members of a ring structure (discussed further below). The first nonionic surfactant may have a variety of types and structures. For example, major types of the first nonionic surfactant include fatty alcohol ethoxylate/butoxylate, alkyl phenol ethoxylate/butoxylate, fatty acid ethoxylate/butoxylate, combinations of these, and the like.

In preferred embodiments, R¹, R², R³, R⁴, R⁵, R⁶, R⁷, R⁸, R⁹, R¹⁰, R¹¹, and R¹² are individually selected from hydrogen and linear or branched C1-C5 alkyl groups. In more preferred embodiments, R¹, R², R³, R⁴, R⁵, R⁶, R⁷, R⁸, R⁹, R¹⁰, R¹¹, and R¹² are individually selected from hydrogen and methyl. In most preferred embodiments, each of R¹, R², R³, R⁴, R⁵, R⁶, R⁷, R⁸, R⁹, R¹⁰, R¹¹, and R¹² is hydrogen, that is the ethylene oxide groups in the plurality of ethylene oxide groups are unsubstituted and have the formula —CH₂CH₂O—, and the butylene oxide groups in the plurality of butylene oxide groups are unsubstituted and have the formula —CH₂CH₂CH₂CH₂O—.

As an option, in the ethylene oxide groups, any of R¹, R², R³, and R⁴ may be a co-member of a ring structure with one or more of the other R¹, R², R³, and R⁴ groups. For example, R¹ may connect to R³ in a ring structure, and/or R² may connect to R⁴ in a ring structure. Alternatively, and more preferably, each of R¹, R², R³, and R⁴ may be a discrete hydrocarbyl group or hydrogen.

Similarly, as an option in the butylene oxide groups, any of R⁵, R⁶, R⁷, R⁸, R⁹, R¹⁰, R¹¹, and R¹² may be a co-member of a ring structure with one or more of the other R⁵, R⁶, R⁷, R⁸, R⁹, R¹⁰, R¹¹, and R¹² groups. For example, R⁵ may connect with R⁷ to form a hydrocarbyl ring structure; R⁶ with R⁸; R⁷ with R⁹, R⁸ with R¹⁰; R⁹ with R¹¹, and/or R¹⁰ with R¹² to form a hydrocarbyl ring structure. Alternatively, and more preferably, each of R⁵, R⁶, R⁷, R⁸, R⁹, R¹⁰, R¹¹, and R¹² may be a discrete hydrocarbyl group or hydrogen.

In some illustrative embodiments of the first nonionic surfactant, the molar ratio of butylene oxide to ethylene oxide groups may be 1:100 to 100:1, 50:1 to 1:50, 1:20 to 20:1, 1:4 to 4:1, 2:4 to 4:1, 3:4 to 4:1, 1:1 to 4:1, 1:4 to 3:1 1:4 to 2:1, or 1:4 to 1:1.

In some embodiments, the number average formula weight of the alkoxylate portion may be selected from a wide range. Generally, the number average molecular weight may be from 44 to 2000 Daltons, or 44 and 1000 Daltons, or from 43 Daltons to 721 Daltons.

The first nonionic surfactant may be insoluble in water at 20° C. or may have a solubility of 0 g per liter of water to 1 g/liter, or 0 g/liter to 0.1 g/liter, or 0 g/liter to 0.01 g/liter, or 0.001 g/liter to 1 g/liter, or 0.001 g/liter to 0.1 g/liter of water.

In illustrative embodiments, the first nonionic surfactant at 1 g/liter concentration in distilled water at 20° C. as measured by DIN 53914 (1997) may have a surface tension of about 10-40, or about 20-50, or about 20-40, or about 25 to about 35 or about 30 mN/m.

In illustrative embodiments, the viscosity of the first nonionic surfactant as measured by Brookfield viscometer (available for example from AMETEK-Brookfield of Middleboro, MA, USA) at 60 rpm may be about 30 to about 60, or about 30 to about 50 at 25° C. The viscosity of the first nonionic surfactant as measured by Brookfield viscometer at 60 rpm may be about 50 to about 120, or about 70 to about 100, or about 80 to 100, or about 85 to about 95, or about 90 centipoise (cP) at 10° C. The viscosity of the first nonionic surfactant as measured by Brookfield viscometer at 60 rpm may be about 2500 to about 3500, or about 2600 to about 3200, or about 2600 to about 2900, or about 2600 to about 3000, or about 2800 cP at 10° C.

In some embodiments, the first nonionic surfactant may comprise, consist of, or consist essentially of an alkoxylated alcohol. The alkoxylated alcohol may be the reaction product of substituted or unsubstituted ethylene oxide, substituted or unsubstituted butylene oxide, and a fatty alcohol. Alternatively, the alkoxylated alcohol may be the reaction product of ethylene glycol, a butylene glycol, and a fatty alcohol. The fatty alcohol may include 4 to 26 carbon atoms, for example 4 to 26 carbon atoms, or 6 to 20 carbon atoms, or 8 to 18 carbon atoms, or 10 to 8 carbon atoms or 10 to 16 carbon atoms, or 8 to 16 carbon atoms. The fatty alcohol may be a mixture of fatty alcohols collectively having an average number of carbon atoms of 10 to 16 and collectively comprising predominantly unbranched hydrocarbyl portions.

The first nonionic surfactant may comprise, consist of, or consist essentially of an alkoxylated alcohol having the formula Bh—O-(Ax)-Y, wherein the hydrocarbyl portion Bh is a C10 to C16 alkyl group, and wherein more than 50 mol % of the hydrocarbyl portions within the plurality of alkoxylated alcohol compounds are unbranched alkyl, for example 51%-100% or 60% to 100%, or 70% to 100%, or 80% to 100%, or 90% to 100%, or 51% to 99%, or 51% to 95%, or 80% to 95% by moles.

In a representative embodiment, the first nonionic surfactant may comprise, consist of, or consist essentially of an alkoxylated alcohol having the formula Bh—O-(Ax)-Y, wherein Bh is a hydrocarbyl portion; O is an oxygen atom; Ax is an alkoxylate portion comprising the EO and BO content as described hereinabove; and Y is hydrogen, a hydrocarbyl group, or nonionic other monovalent moiety.

The hydrocarbyl portions, Bh, may be selected from a wide range of linear, branched, or cyclic moieties. In some embodiments, Bh may have 4 to 26 carbon atoms, or 6 to 20 carbon atoms or 8 to 18 carbon atoms, or 10 to 8 carbon atoms or 10 to 16 carbon atoms, or 8 to 16 carbon atoms. The hydrocarbyl portion Bh may comprise one or more of alkyl, alkylene, and aryl. Non-limiting examples of Bh include C10-C16 alkyl, such as predominantly unbranched C10-C16.

If Y is a hydrocarbyl group, then Y may be selected from a wide range of linear, branched, or cyclic moieties. In some embodiments, Y may have 4 to 26 carbon atoms, or 6 to 20 carbon atoms or 8 to 18 carbon atoms, or 10 to 8 carbon atoms or 10 to 16 carbon atoms, or 8 to 16 carbon atoms. If Y is a hydrocarbyl group, then Y may comprise one or more of alkyl, alkylene, and aryl. If Y is a hydrocarbyl group, then Y may be the same or different from Bh.

Suitable nonionic surfactants for use as the first nonionic surfactant are available from BASF under the tradename PLURAFAC®. Nonlimiting examples include PLURAFAC LF 224 and PLURAFAC LF 403. Alternatively, suitable first nonionic surfactants may be prepared by synthesis methods well known to the skilled person. Alkoxylated alcohol surfactants may be synthesized, for example, as disclosed in U.S. Pat. No. 3,682,849. It is further believed that the procedures of Sindija Brica, Maris Klavins & Andris | Zicmanis Chris Smith (Reviewing Editor) (2016) A route to simple nonionic surfactants, Cogent Chemistry, 2:1, DOI: 10.1080/23312009.2016.1178830 could also be used by acylation of fatty amines with ethylene carbonate and butylene carbonate. Synthesis procedures also are described in Chapter 5 of Richard J Farn, Chemistry and Technology of Surfactants, John Wiley & Sons (Apr. 15, 2008).

### Second Nonionic Surfactant

The second nonionic surfactant is different from the first nonionic surfactant and comprises a plurality of substituted or unsubstituted ethylene oxide (—CR¹³R¹⁴—CR¹⁵R¹⁶—O—) groups. R¹³, R¹⁴, R¹⁵, and R¹⁶ are individually selected from hydrogen and one or more types of monovalent moiety such as one or more types of hydrocarbyl group. In preferred embodiments, R¹³, R¹⁴, R¹⁵, and R¹⁶ are individually selected from hydrogen and C1-C5 alkyl groups. In more preferred embodiments, R¹³, R¹⁴, R¹⁵, and R¹⁶ are individually selected from hydrogen and methyl. In most preferred embodiments, each of R¹³, R¹⁴, R¹⁵, and R¹⁶ is hydrogen.

The second nonionic surfactant may have a variety of types and structures. For example, major types of the second nonionic surfactant include fatty alcohol ethoxylate, alkyl phenol ethoxylate, fatty acid ethoxylate, combinations of these, and the like.

R¹³ may connect to R¹⁴ or R¹⁵ in a ring structure. R¹⁴ may connect to R¹⁶ in a ring structure. Alternatively, each of R¹³, R¹⁴, R¹⁵, and R¹⁶ may be a discrete hydrocarbyl group or hydrogen.

In some embodiments, the HLB value of the second nonionic surfactant may be 5 to 20, or 10 to 15, or about 12, or 12.1.

In some embodiments, the pH of a 1 wt % aqueous solution of the second nonionic surfactant in water may be 5-8 or 6-7 or about 6.8 at 25° C.

In some embodiments, surface tension at 25° C. of a 1 wt % aqueous solution of the second nonionic surfactant may be 20-50 or 20-40, or 25-35, or about 30 dynes/cm as measured by DIN 53914 (1997).

In some embodiments, the second nonionic surfactant may comprise, consist of, or consist essentially of an alkoxylated alcohol. The alkoxylated alcohol may be the reaction product of substituted or unsubstituted ethylene oxide with a fatty alcohol. Alternatively, the alkoxylated alcohol may be the reaction product of ethylene glycol with a fatty alcohol. The fatty alcohol may include a wide variety of carbon atoms. In a non-limiting example, the fatty alcohol may include 4 to 26 carbon atoms, for example 4 to 26 carbon atoms, or 6 to 20 carbon atoms, or 8 to 18 carbon atoms, 10 to 16 carbon atoms, or 8 to 16 carbon atoms. The fatty alcohol may be a mixture of fatty alcohols collectively having an average number of carbon atoms of about 12 to 14 and collectively comprising predominantly secondary hydrocarbyl portions.

The second nonionic surfactant may comprise, consist of, or consist essentially of an alkoxylated alcohol having the formula Ch-O-(Ex)-Z, wherein Ch is a hydrocarbyl portion, Ex is an alkoxylate portion comprising the ethylene oxide content as described above, O is oxygen, and Z is hydrogen, a hydrocarbyl group, or other nonionic monovalent entity.

The alkoxylate portion may comprise, consist, or consist essentially of substituted or unsubstituted ethylene oxide groups (CR¹³R¹⁴—CR¹⁵R¹⁶—O). R¹³, R¹⁴, R¹⁵, and R¹⁶ are individually selected from hydrogen and one or more types of hydrocarbyl group. In preferred embodiments, R¹³, R¹⁴, R¹⁵, and R¹⁶ are individually selected from hydrogen and C1-C5 alkyl groups. In more preferred embodiments, R¹³, R¹⁴, R¹⁵, and R¹⁶ are individually selected from hydrogen and methyl. In most preferred embodiments, each of R¹³, R¹⁴, R¹⁵, and R¹⁶ is hydrogen, that is the ethylene oxide groups in the plurality of ethylene oxide groups in the second nonionic surfactant are unsubstituted ethylene oxide groups.

The total number of ethylene oxide groups in the alkoxylate portions may be from 1-30 or 1-25, or 15 to 25, or 1-20, or 1-15, or 1-10, or 1-5, or 5-10 or about 7.

In some embodiments, the number average formula weight of the second nonionic surfactant may be 200 to 800 Daltons, or 400 to 600 Daltons or 450 Daltons to 550 Daltons, or about 508 Daltons.

In some embodiments, the hydrocarbyl portion, Ch, may have 4 to 26 carbon atoms, or 6 to 20 carbon atoms or 8 to 18 carbon atoms, or 12 to 14 carbon atoms or 10 to 16 carbon atoms, or 8 to 16 carbon atoms. The hydrocarbyl portion Ch may comprise one or more of alkyl, alkylene, and aryl.

If Z is a hydrocarbyl group, then Z may have 4 to 26 carbon atoms, or 6 to 20 carbon atoms or 8 to 18 carbon atoms, or 12 to 14 carbon atoms or 10 to 16 carbon atoms, or 8 to 16 carbon atoms. The hydrocarbyl portion Z may comprise one or more of alkyl, alkylene, and aryl. If Z is a hydrocarbyl portion, then Z may be the same or different from hydrocarbyl portion Ch.

The second nonionic surfactant may comprise, consist of, or consist essentially of an alkoxylated alcohol, wherein the alkoxylated alcohol is the reaction product of a substituted or unsubstituted ethylene oxide, and a fatty alcohol. The fatty alcohol may include 4 to 26 carbon atoms, for example 4 to 26 carbon atoms, or 6 to 20 carbon atoms, or 8 to 18 carbon atoms, or 9 to 15, or 12 to 14 carbon atoms, or 10 to 16 carbon atoms, or 8 to 16 carbon atoms. The fatty alcohol may have an average number of carbon atoms of 10 to 14 and Ch may be a secondary alkyl hydrocarbyl portion.

The second nonionic surfactant may comprise, consist of, or consist essentially of an alkoxylated alcohol having the formula Ch-O-(Ex)-Z, wherein the hydrocarbyl portion Ch is a C12 to C14 alkyl group, and wherein more than 50 mol % of the hydrocarbyl portions within the alkoxylated alcohol is secondary alkyl, for example 51%-100% or 60% to 100%, or 70% to 100%, or 80% to 100%, or 90% to 100%, or 95% to 100%, or 51% to 99%, or 51% to 95%, or 80% to 95%, or about 100% by moles.

Suitable examples of the second ionic surfactant are available from available from Dow Chemical Company, Midland, Michigan, USA under the brand name TERGITOL™. Examples include the TERGITOL 15-S range of surfactants. Alkoxylated alcohol surfactants may be synthesized, for example, as set forth in U.S. Pat. No. 2,870,220.

The treatment compositions of the present invention optionally may include one or more additional ingredients such as a liquid carrier (preferably an aqueous liquid carrier), one or more polysiloxanes, one or more fungicides, one or more biocides, one or more antistatic agents, one or more fluorescent compounds, one or more optical brighteners, one or more dyes, one or more pigments, combinations of these and the like.

Optionally, the treatment compositions may further comprise at least one polysiloxane such as polydimethylsiloxane. The polysiloxane(s) may comprise a polysiloxane-modified silica. If present, the weight ratio of the polysiloxane(s) (if present) to the second nonionic surfactant may be 1:10 to 10:1, or 1:5 to 5:1 or 1:2 to 2:1, or 1:10 to 1:1, or 1:1 to 1:10, or 1:1 to 5:1, or 5:1 to 1:1, or about 1:1.

In some embodiments, the amount of optional polysiloxane(s) is limited or avoided. In such embodiments, the weight ratio of the polysiloxane(s) to the second nonionic surfactant is in the range from 0:10000 to 1:10000, or 0:1000000 to 1:1000000.

### Aqueous Treatment Compositions

In preferred embodiments, the treatment compositions in the practice of the present invention are in the form of aqueous treatment compositions. An aqueous treatment composition of the present invention results when the treatment composition comprises, consists of, or consists essentially of any of the treatment compositions disclosed hereinabove and an aqueous liquid carrier. The aqueous liquid carrier comprises, consists of, or consists essentially of water. As an option, in addition to water, the aqueous liquid carrier may comprise, consist of, or consist essentially of water and one or more water-soluble organic carrier liquids. The one or more water-soluble organic carrier liquids may include one or more alcohols (such as ethanol, isopropanol, n-propanol, n-butanol, isobutanol, t-butanol, an amyl alcohol, a hexanol, propane diol, butane diol, pentane diol, glycerol, ethylene glycol, propylene glycol, combinations of these and the like) and/or other water-soluble organic carrier liquids (such as acetone, acetonitrile, diethanolamine, dimethyl sulfoxide, 1,4-dioxane, ethylamine, N-methyl-2-pyrrolidone, acetic acid, propanoic acid, tetrahydrofuran, combinations of these, and the like).

### Deploying Treatment Compositions Including the First and Second Nonionic Surfactants

Various methods may be used to deploy treatment compositions of the present invention. For example, the first and second nonionic surfactants, and optionally one or more other desired ingredients (if any) may be dissolved, dispersed or otherwise incorporated into a liquid carrier, such as an aqueous carrier liquid, in a form effective for the desired end use. As another option, the first and second nonionic surfactants, and optionally one or more other desired ingredients (if any) may be dissolved, dispersed or otherwise incorporated into one or more concentrate treatment compositions that subsequently are further diluted with liquid carrier and optionally combined with one or more optional ingredients in order to finalize the treatment composition into a suitable form used to carry out the desired treatment. At least a portion of the other, optional ingredients may be incorporated into the one or more concentrate compositions or formulated into the resultant treatment composition in combination with the concentrate composition(s). Precursor compositions corresponding to a concentrate or final treatment composition form also may be used.

In an illustrative mode of practice, the end use is to provide and use a treatment composition in the form of a recirculating cooling medium. The cooling medium is useful to help cool and to treat flowable polymer bodies in the form of polymer pellets. Such a treatment composition is useful to contact a plurality of flowable solid polymer bodies not only for cooling the polymer bodies after extrusion but also to help provide functionality including reducing the tendency of the polymer bodies to block with each other or foul equipment as well as to help reduce drying temperatures and polymer degradation associated with higher drying temperatures.

For example, the first nonionic surfactant and optionally one or more additional, optional ingredients, if desired, may be dispersed, dissolved, or otherwise incorporated in an aqueous carrier liquid to form a first precursor composition. The second nonionic surfactant and optionally one or more additional, optional ingredients if desired, may be dispersed, dissolved, or otherwise incorporated in an aqueous carrier to form a second aqueous precursor composition. Optionally, one or both of the precursor compositions may be supplied in neat form, i.e., without any liquid carrier.

The first and second precursor compositions may be provided to an end-user as a kit. The kit comprises a first kit component comprising the first precursor composition comprising the first nonionic surfactant. A separate kit component comprises a second precursor composition comprising the second nonionic surfactant. The first precursor composition may comprise, consist of, or consist essentially of the first nonionic surfactant, optionally an aqueous liquid carrier, and one or more optional ingredients. The second precursor composition may comprise, consist of, or consist essentially of the second nonionic surfactant, an aqueous liquid carrier, and one or more optional ingredients.

In use, the first and second aqueous precursor compositions along with additional aqueous liquid carrier material and optionally one or more additional optional ingredients may be combined together to produce the desired aqueous treatment composition useful, for example, as spray water or as extruder-pelletizer cooling water. In the latter use, the aqueous treatment composition is useful to contact the plurality of flowable solid polymer bodies for cooling as well as for protection against blocking, and fouling also while facilitating use of lower drying temperatures. As a consequence of using additional liquid carrier material, the first and second precursor compositions are diluted to form the resultant treatment composition.

The use of the first and second precursor compositions to prepare the resultant treatment composition may occur in a variety of ways. For example, the first and second precursor compositions first may be combined together by the end-user to form a treatment composition in the form of a concentrate treatment composition. Then the concentrate is diluted with additional liquid carrier and optionally further combined with one or more optional ingredients incorporated into the treatment composition. Alternatively, as another example the end user may separately incorporate the first precursor composition and the second precursor composition, either sequentially in any order or at the same time, into an existing cooling medium under conditions effective to provide a resulting treatment composition with a desired concentration of the first and second nonionic surfactants, respectively. The treatment composition may be formed continuously or as a batch.

As another example, the first nonionic surfactant, the second nonionic surfactant, optionally an aqueous liquid carrier, and optionally one or more additional, optional ingredients, if desired, may be formulated into a single concentrate treatment composition of the present invention. Optionally, the concentrate treatment composition may be supplied in neat form, i.e., without any liquid carrier. In use, the single aqueous concentrate treatment composition along with additional aqueous liquid carrier material and optionally one or more additional optional ingredients may be combined together to produce the desired aqueous treatment composition useful, for example, as spray water or extruder-pelletizer cooling water. As a consequence of using additional liquid carrier material, the single concentrate treatment composition is diluted to form the resultant treatment composition.

### Methods of Treating Flowable Solid Polymer Bodies

A method of treating a plurality of flowable solid polymer bodies comprises contacting the plurality of flowable solid polymer bodies with an aqueous treatment composition of the present invention as described above to form an admixture, wherein the admixture comprises, consists of, or consists essentially of the plurality of the flowable solid polymer bodies, the aqueous treatment composition. The aqueous treatment composition comprises, consists of, or consists essentially of water, the first nonionic surfactant as described hereinabove, and the second nonionic surfactant as described hereinabove. As described above, the aqueous treatment composition optionally may comprise one or more optional ingredients.

The first nonionic surfactant, the second nonionic surfactant, water, and the plurality of flowable polymer bodies may be combined in any order. However, in a preferred exemplary method, an aqueous dispersion of the first nonionic surfactant is added to an in-situ aqueous dispersion or solution of the second nonionic surfactant to provide the aqueous treatment composition. The aqueous first nonionic surfactant may be added to the aqueous second nonionic surfactant before, during, or after any agitation of the aqueous second nonionic surfactant. Then the combination of aqueous first and second nonionic surfactants may contact the plurality of polymer pellets.

As used herein, a solid polymer body is a discrete mass comprising at least one solid polymeric material. As used herein, solid polymeric material means any oligomer or polymer that is a solid at 25° C. and 1 atmosphere of pressure. Exemplary solid polymeric materials are those that have a number average molecular weight of at least 500, or at least 750, or at least 1500, or at least 2500. Some solid polymeric materials, such as ultrahigh molecular weight polyethylene may even have number average molecular weights in the millions, such as from 3.5 million to 7.5 million. Accordingly, in some embodiments, a solid polymeric material may have a number average molecular weight up to about 8 million, or up to about 5 million, or up to about 2 million, or up to about 500,000, or up to about 250,000, or up to about 100,000, or up to about 50,000, or up to about 25,000.

As used herein, “flowable solid polymer bodies” refers to a plurality of solid polymer bodies that may collectively flow or be fluidized, such as when being acted upon by one or more forces, for example the force of gravity. Flowable solid polymer bodies may have a variety of forms. Nonlimiting examples of forms for the flowable solid polymer bodies include powders, dusts, fines, beads, spheroids, granules, grains, pellets, chunks, particles, and the like, and combinations of these.

A plurality of the flowable solid polymer bodies may comprise polymer bodies with a variety of sizes. The plurality of polymer bodies may have a distribution of sizes. The distribution may be irregular, monomodal, or multimodal such as bimodal. The plurality of solid polymer bodies may comprise, consist of, or consist essentially of an irregular distribution of polymer body sizes or a regular distribution of body sizes, such as a log-normal distribution of sizes, a Gaussian distribution, a Weibull distribution, or other type of distribution of body sizes.

The plurality of flowable solid polymer bodies may comprise, consist, or consist essentially of solid polymer bodies having size characteristics selected from a wide range of sizes, depending on factors such as the intended mode of use, method of fabrication, and the like. In illustrative modes of practice, flowable solid polymer bodies may comprise, consist, or consist essentially of solid polymer bodies having a longest size in any one dimension of 0.5 microns (micrometers) to 20 cm, or 1 micron to 10 centimeter, or 1 micron to 5 millimeters, or 1 micron to 1500 microns, or 1 micron to 1000 microns.

Although these ranges refer to the longest size in any one dimension, these same ranges also are illustrative of the size characteristics of a population of a plurality of flowable solid polymer bodies in terms of average particle (or body) size and/or a median particle size. The plurality of flowable solid polymer bodies may or may not include fines. Fines are flowable solid polymer bodies having a longest size in any one dimension of under 500 microns such as in a size range from 0.1 microns to 500 microns.

The longest dimension size, average particle size and/or median particle size may be measured by a wide range of techniques such as sieve analysis, sedimentation (e.g. hydrometer or pipette method), dynamic image analysis, laser diffraction, static image analysis, and dynamic light scattering. However, for the purposes of the present invention, preferably the particle size of polymer bodies is measured by laser diffraction.

In preferred modes of practice, dried, the flowable characteristics of flowable, solid polymer bodies are measured using a Pipe Test. According to the Pipe Test, flowable, solid polymer bodies treated in accordance with the present invention have a mass flow rate of at least 3 polymer bodies, or at least 10 polymer bodies per second or even at least 25 polymer bodies per second downward when dispensed from a hopper under the force of gravity through a polished, stainless steel (304 grade), vertical, cylindrical pipe having a diameter of at least 20 times the longest size dimension of the polymer bodies being tested. Flowable solid polymer bodies as described herein are not particularly limited by shape and may have a single shape or a variety of shapes. Non-limiting examples of shapes of the bodies are irregular shapes, spherical, ovoid, cubic, cuboid, lozenge, cylindrical, pyramidal, ellipsoid, conical, frustoconical, trapezoidal prismatic, shapes approximating to any of the foregoing, and any combination thereof.

The polymeric material(s) used to form the solid, flowable polymer bodies may include at least one organic polymer and/or at least inorganic polymer. An organic polymer is a polymer that comprises at least one C atom in the backbone. An inorganic polymer is a polymer that does not include any C atoms in the backbone. In many embodiments, the polymeric material may include at least one natural and/or synthetic organic polymer. The polymeric material may have a variety of backbone configurations including linear, branched, cyclic, and combinations of these. The polymeric material may be aromatic or aliphatic. The polymeric material may be saturated or unsaturated. The polymeric material may be substituted or include pendant functionality such as hydroxyl, amine, carbon-carbon double bonds, ether, ester, nitrile, epoxide, carboxylate, sulfonate, phosphate, quaternary ammonium, thio, phenyl, hydrocarbyl, combinations of these, and the like. The backbone(s) may include one or more heteroatoms such as P, S, N, and/or O.

Nonlimiting and illustrative examples of suitable organic polymers include polyethylene; polystyrene; polypropylene; other olefin polymers and copolymers such as ethylene-propylene copolymers and ethylene-vinyl acetate copolymers, as well as combinations thereof, polyurethane, polyester, polycarbonate, protein, starch, polyvinyl chloride, fluoropolymer, polyacetal, polyamide, polyimide, poly(meth)acrylate, cellulose, acrylonitrile, combinations of these, and the like. Examples of inorganic polymer materials include one or more of polysulfide, polysilane, polysiloxane, polyphosphazene, polyborazylene, polyaminoborane, polythiazyl, polyphosphate, polyborate, combinations of these, and the like.

In the present context, “copolymer” signifies polymers made with two or more chemically distinct types of monomer. The term “copolymer” therefore includes copolymers including two types of monomer residue, three types of polymer residue (terpolymers), four types of monomer residue (quadrapolymers), and polymers comprising five or more types of monomer residue. The flowable solid polymer bodies may comprise, consist of, or consist essentially of a plurality of polymer pellets. Polymer pellets are flowable solid polymer bodies that may be made by extrusion-pelletization processes. In illustrative modes of practice in which polymer pellets are used as a source material to fabricate polymer-containing articles, a typical polymer pellet may have a maximum length in any one dimension of each polymer pellet may be 0.7 microns to 2 millimeters, or 0.7 microns to 1.5 millimeters, or 1 micron to 1 millimeter. The polymer pellets may come in a variety of forms such as in the form of a bead, spheroid, cylinder, flake, chip, slice, fragment, or any other form. As used herein the term “pellet” does not refer to latex/emulsion micelles.

The flowable solid polymer bodies may or may not include fines (solid polymer particles having a diameter in the longest dimension of 1-500 microns). Flowable solid polymer bodies including fines are particularly prone to fouling surfaces with which they come into contact, even when borne by a liquid such as water. However, admixtures of the flowable solid polymer bodies and the aqueous treatment compositions of the invention advantageously may be less prone to unduly foul surfaces with which they come into contact, than, for example, admixtures of the flowable solid polymer bodies with an aqueous carrier fluid absent both the first and second nonionic surfactants.

After contacting the plurality of flowable solid polymer bodies with an aqueous treatment composition of the present invention, the method may further comprise separating at least a portion of the treatment composition from at least a portion of the treated, flowable solid polymer bodies in the admixture thereof. The separating may be performed by filtration, centrifuging, decanting, or any combination thereof. Advantageously, at least a portion of the treatment composition that is separated from the bulk of the treated, flowable solid polymer bodies may be reused to treat further flowable solid polymer bodies, with or without additional water, additional first nonionic surfactant, and/or additional second nonionic surfactant.

Often in separating the treated, flowable solid polymer bodies and treatment composition, the bulk of the flowable solid polymer bodies is separated from the bulk of the treatment composition. However, at least a portion of the surface of the bulk of the flowable solid polymer bodies may still be wet with some of the treatment composition. Consequently, the method may further comprise drying the treated, flowable solid polymer bodies to remove the residual treatment composition. The wet flowable solid polymer bodies may be dried, for example in a centrifugal dryer, when the majority of the water and/or any other volatile solvents in the aqueous treatment composition evaporates.

For example, when stored in containments such as silos, handling and retrieval of the flowable solid polymer bodies from the containment may rely on gravity or other forces to allow the flowable solid polymer bodies collectively to flow from the containment when the containment is opened. Flowable solid polymer bodies may, however, exhibit poor flow from the containment or even be retained therein. For example, adhesion of the flowable solid polymer bodies to each other and the interior surfaces of the containment with which they are in contact may be sufficient to impede or even prevent free flow of the flowable solid polymer bodies. However, dried flowable solid polymer bodies previously treated with the treatment composition by contact therewith may flow from containments more easily than like flowable solid polymer bodies that have not been treated with the treatment composition. The flow is even better if both the polymer bodies and the containment surfaces are treated with treatment compositions of the present invention. The use of treatment compositions of the present invention to treat surfaces to reduce fouling is described further below.

The flowable solid polymer bodies or the precursors thereof (e.g., molten forms before, during, and/or after pelletizing) in the present methods may be hot. Advantageously, the aqueous treatment compositions of the present invention may be effective to both treat the flowable solid polymer bodies and to cool the solid polymer bodies.

In the present context, “hot” may refer to any temperature above 30° C., for example 30° C. to 300° C., or 60° C. to 250° C., or 90° C. to 200° C., or 50° C. to 100° C., or 100° C. to 200° C., or 50° C. to 250° C., or 60° C. to 110° C. or 70° C. to 110° C., or 80° C. to 110° C. or 40° C. to 100° C., or 60° C. to 100° C., or 70° C. to 100° C.

The treatment compositions described herein may be used as cooling compositions in such methods when the flowable solid polymer bodies or molten precursors thereof are hot. In some such embodiments, the flowable solid polymer bodies, may be at a temperature below or even between their glass transition temperature and their melting point upon contact with the treatment composition. Molten precursors thereof may be at temperatures above the glass transition temperature or even above the melting point. In the practice of the present invention, glass transition temperature is measured using differential scanning calorimetry techniques. The melting point is determined by differential scanning calorimetry techniques.

The cooling composition may be at any suitable temperature effective to cool the polymer material to a desired cooled temperature. In some modes of practice, a treatment composition when also used as cooling media may be supplied at a temperature of less than 100° C. before the treatment composition contacts the flowable hot polymer bodies or precursors thereof, or less than 90° C., or less than 80° C., or less than 70° C., or less than 60° C., or less than 50° C., or less than 25° C., or less than 10° C.

### Methods of Extrusion

According to one aspect of the present invention, a method of extrusion comprises melt-extruding a polymer and contacting the extrudate with any of the aqueous treatment compositions described herein. The aqueous treatment composition may act both to treat and cool the extrudate.

The polymer may be extruded into a bath or other containment comprising the aqueous treatment composition, and/or the aqueous treatment composition may be sprayed, poured, or otherwise applied to or caused to contact the extrudate.

The method may further comprise dividing the extrudate into flowable solid polymer bodies either while still molten or partially molten or after being solidified. The extrudate may be divided before, during, and/or after contact with the aqueous treatment composition.

The divided extrudate may form an admixture with the treatment composition. The admixture may comprise, consist of, or consist essentially of the flowable solid polymer bodies and the treatment composition.

Division of the extrudate may comprise, consist of, or consist essentially of pelletization. If the extrudate is pelletized, the resulting polymer pellets may have any of the sizes, shapes described hereinabove.

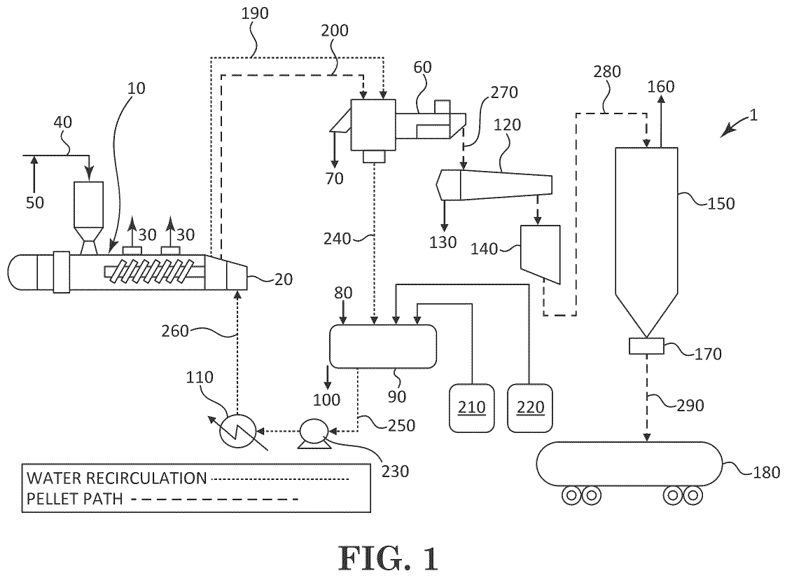

Exemplary embodiments of methods of extrusion and pelletization will now be described in relation to FIG. 1. FIG. 1 schematically represents a system 1 and associated process of polymer extrusion and pelletization with the following components and features:

### PARTS LIST

1 System
10 Screw extruder
20 Pelletizer
30 Vacuum
40 Polymer, e.g. from reaction
50 Additives
60 Centrifugal dryer
70 Scrap pellets
80 Makeup water
90 Water tank
100 Blowdown
110 Heat exchanger
120 Classifier
130 Scrap
140 Check hopper
150 Silo
160 Vapors
170 Rotary vane feeder
180 Railcar
190 Cooling water
200 Initially pelletized pellets
210 Supply tank 1
220 Supply tank 2
230 Pump
240 Cooling water
250 Cooling water
260 Cooling water
270 At least partially dried pellets
280 Classified pellets
290 Pellets
300 Surface
310 Spray
320 Nozzle
330 Coating

In System 1, polymer 40 is fed into a screw extruder 10 along with additives 50 to be compounded into the polymer through the extruder action. The polymer is melted within the screw extruder 10 and extruded in molten form into pelletizer 20, where the polymer is cooled by combination and resulting contact with cooling water 260 and is pelletized to form polymer pellets 200. Generally, pelletizing causes the polymer to be cut, chopped, or otherwise separated into smaller, discrete pieces of polymer. The molten polymer 40 and/or resulting solid pellets 200, as the case may be, may be first contacted with the cooling water 260 before, during, and/or after pelletization. In illustrative modes of practice, the cooling water 260 will provide cooling to the molten polymer 40 in a manner effective to bring the polymer 40 below its melting point and also preferably below its softening point so that the previously molten polymer 40 becomes solid, thereby facilitating the pelletization process while the extruded polymer 40 is in solid form. Accordingly, preferably cooling water 260 contacts the extruded polymer 40 before and/or during pelletization. For example, the molten polymer 40 may be extruded into the cooling water 260 and pelletized therein. Alternatively, the molten polymer 40 may be subdivided into smaller portions and thereafter sufficiently cooled by contact with cooling water 260 to solidify the smaller portions into solid pellets 200.

An admixture comprising solid pellets 200 and post-pelletization cooling water 190 flows to centrifugal dryer 60, which separates most of pellets 200 from at least a portion, and desirably most of cooling water 190 by drying action to produce at least partially dried pellets 270. Some of the pellets 270 being dried may be separated as scrap 70 that might be discarded, recycled, and/or otherwise handled or processed. The remainder of the dried pellets 270 flow to classifier 120, where the pellets 270 may be sorted by size and whence the resulting classified pellets 280 are conveyed via check hopper 140 to silo 150, where additional drying and/or degassing of vapors 160 from the pellets may occur.

After separation from the dried pellets 270, separated cooling water 240 is recycled by being initially fed to water tank 90, where cooling water 240 may be combined with makeup water 80 to provide a reservoir of cooling water 250. The cooling water 240 is still hot from contacting and cooling the freshly extruded polymer 40. The resultant reservoir of cooling water 250 also may be hotter than desired for effective recycling back to the pelletizer 20. Accordingly, cooling water 250 is pumped by pump 230 from the water tank 90 to a heat exchanger 110, where the cooling water is cooled to a suitable temperature to provide cooling water 260 in preparation for reuse to cool the molten polymer 40 in pelletizer 20. Accordingly, there is a circuit of cooling water (cooling liquid recirculation), which flows to the pelletizer 20, to dryer 60, to tank 90, heat exchanger 110, and back to pelletizer 20.

While most of the dried pellets 270 are separated from cooling water 240, some pellet material including at least a portion of fines (defined above) may still be entrained or otherwise carried in cooling water 240. Such entrained pellet material may travel with cooling water 240 to tank 90 and then to pump 230, heat exchanger 110, and back to pelletizer 20.

Untreated, dried polymer pellets in general and fines in particular may adhere to each other (blocking) as well to surfaces with which they come into contact. This is also true of pellets that are present within cooling water. Accordingly, in prior art processes, surfaces of the equipment in system 1 of FIG. 1 that contact the admixture of water and pellet material and/or dried pellet material may become fouled with polymer such as adherent fines. Such fouling and blocking reduces flow in the cooling water circuit and may impede or even block flow in the circuit of the cooling water. The flow of the solid polymer pellets also may be impeded. Accordingly, in prior art processes, the extrusion operation must be periodically shut down more often than desired to clean heat exchanger surfaces and other surfaces that become fouled. This reduces productivity and entails inconveniences associated with the cleaning process such as water and other material usage, thereby increasing costs due, for example, to lost productivity, and increased labor and materials costs. Also, untreated polymer material tends to require higher drying temperatures, which risks polymer degradation with increased temperature and/or increased residence time at higher temperature.

Advantageously, using treatment compositions of the present invention as cooling media in pelletization systems such as system 1 of FIG. 1 not only may reduce blocking and fouling, but also drying temperatures and/or residence time can be reduced to reduce the risk of polymer degradation.

Accordingly, the treatment compositions of the present invention as described herein may be combined and dispersed in the cooling water 260, 190, 240, and 250 to provide diluted treatment compositions of the present invention. As described above, a treatment composition of the present invention comprises the first and second nonionic surfactants, and optionally may also comprise a suitable liquid carrier, polydimethylsiloxane and/or other optional components as described herein. The first and second nonionic surfactants, and any other components of the treatment composition, may be added together or separately to any one or more of the cooling water 260, 190, 240, and 250 at any convenient location or locations in the circuit of cooling water, whereby the cooling water functions not only to cool the polymer material but also is a treatment composition of the present invention. The components of the treatment composition may be added to the cooling water circuit at the same time and/or at different times from each other.

The components of the treatment composition may be added at the same location of the cooling water circuit or at separate locations. For example, as depicted in FIG. 1, first and second nonionic surfactants may be added to the cooling water 250 in water tank 90 from supply tank 210 (comprising first nonionic surfactant) and supply tank 220 (comprising second nonionic surfactant) respectively. Optionally, one or more optional ingredients may be incorporated into the cooling water 250 as well. These additional optional ingredients, if any, may be provided in supply tank 210 and/or supply tank 220 or a separate tank (not shown). In other exemplary embodiments, the first and second nonionic surfactants may both be added from a single supply tank (not shown). The composition in tank 210 comprising the first nonionic surfactant may be in the form of an aqueous concentrate or as 100% actives (no carrier liquid, also referred to as being “neat”). The composition in tank 220 comprising the second nonionic surfactant may be in the form of an aqueous concentrate, or as 100% actives.

Once the compositions from supply tanks 210 and 220 comprising the first and second nonionic surfactants as described hereinabove and any other components have been added to the cooling water 250, cooling water 250 becomes an aqueous treatment composition of the present invention. Combination of the compositions from tanks 210 and 220 results in dilution of those compositions. The surfactant components of the treatment composition thereby become incorporated into the cooling water 250, 260, etc., and the resultant aqueous treatment composition flows around the cooling-water circuit as cooling water.

When the first and second nonionic surfactants are present within cooling water 250 and then the cooling water 260, the resultant pellets 200 become treated in a manner such that the degree of fouling and blocking may be reduced. Further, the treated pellets 200 can be dried at lower temperature and/or with reduced exposure to higher drying temperatures to reduce polymer degradation. As a further advantage, system 1 requires less maintenance such as cleaning of fouled heat exchanger, pipes, valves, and/or the like. Accordingly, productivity may be increased and labor costs reduced.

Furthermore, when the recirculating cooling water 260, 190, 240, and 250 constitutes a treatment composition of the present invention, pellets 200 including any fines are contacted by the treatment composition. After separation of pellets 270 from the cooling water 240 and drying the pellets, for example in the centrifugal dryer 60, the separated dried pellets 280 have been treated with the treatment composition, that is the pellets 280 have been contacted by the treatment composition and thereby are treated pellets. Treated pellets may be less prone to undue blocking and fouling than pellets that have not been treated with the treatment compositions of the invention. For example, the dried pellets 280 may flow more easily from dryer 60 to classifier 120, from classifier 120 to hopper 140, from hopper 140 to silo 150 where the pellets 280 are stored as pellets 290. Further, the flow of pellets 290 from silo 150, for example under gravity into railcar 180 or other type of further handling, may be improved. Additionally, the treated pellets 200 fed to dryer 60 are easier to dry (e.g., lower temperatures and/or reduced residence time may be used) to provide dried pellets 280. The lower temperatures required for drying the treated pellets may be less prone to cause undesirable heat-effected changes in the polymer pellets; for example surface cracking, yellowing, degradation, and/or other undesirable effects. Without being bound by theory, we speculate that components of the treatment composition are retained on or otherwise incorporated onto or into the surface of the treated as a surface treatment (physical adherence) and/or surface modification (reactive modification) on dried pellets 280, thereby decreasing adhesion among pellets, lowering the surface energy of the interface of the pellets with air, and/or reducing fouling of surfaces contacted by the wet or dry pellets 200, 270, 280, and 290.

### Methods of Treating Surfaces and Resultant Treated Surfaces

In prior art processes, untreated, flowable solid polymer bodies can adhere to or otherwise foul surfaces. Consequently, the movement of flowable solid polymer bodies relative to one or more surfaces may be impeded due to such fouling or adhesion of the flowable solid polymer bodies to the one or more surfaces. When the flowable solid polymer bodies have been treated by the treatment compositions of the invention, the fouling tendencies are significantly reduced. For example, as one benefit, the flow of the flowable solid polymer bodies under a force, for example under gravity, relative to the surfaces may be improved. Nevertheless, to further improve the flow of flowable solid polymer bodies (whether or not treated with a treatment composition of the invention and/or another treatment composition) contacting a surface, the surface may be treated with any of the aqueous treatment compositions of the invention as described hereinabove to provide a surface treatment that would cause the treated surfaces to be more resistant to. In some modes of practice, both the surfaces to be contacted as well as the flowable, solid polymer bodies are treated with a treatment composition of the present invention.

A method of treatment of a surface comprises contacting a surface with an aqueous treatment composition of the present invention in a manner effective to provide a treated surface. Desirably, the treated surface is more resistant to fouling by flowable, solid polymer bodies as compared to an untreated surface. In some preferred aspects, “treated surface” means a surface that is coated with a coating comprising, consisting of, or consisting essentially of the first nonionic surfactant, the second nonionic surfactant, and one or more optional ingredients as disclosed hereinabove with respect to treatment compositions of the present invention. The coating may be a dried coating derived from ingredients comprising at least the aqueous treatment compositions. The aqueous treatment composition may be any of the aqueous treatment compositions of the present invention disclosed herein.

To prepare a treated surface, the step of contacting a surface with an aqueous treatment composition of the present invention may comprise, consist of, or consist essentially of applying the treatment composition to the surface by spray, roller, brush, curtain coating, or any other technique by which a layer, continuous or discontinuous, of the aqueous treatment composition may be deposited on the surface.

Any surface that contacts flowable, solid polymer bodies in dry or wet form can benefit from the surface treatment. For example, the surface may be an interior surface of an apparatus such as a pelletizer, separator, dryer, or the like; piping through which wet or dried pellets are transported, a containment in which wet or dry pellets are stored such as a silo, or any other type of surface.

After the aqueous treatment composition is applied to the surface to be treated, the resultant wet coating is allowed or caused to dry in order to provide the dried surface treatment. For example, the method may further comprise separating at least a portion of the aqueous liquid carrier from the surface to provide a surface treatment comprising a dried coating on all or a portion of the surface being treated. The resultant coating comprises at least a portion of the first nonionic surfactant and at least a portion of the second nonionic surfactant from the applied aqueous treatment composition. Such a separation may be accomplished using any suitable drying technique such as by allowing the surface to dry in air or other atmosphere (e.g., an inert atmosphere such as one comprising one or more of nitrogen, CO₂, argon, and/or the like), with or without assistance from artificially applied heat (such as by heating the surface or the air or atmosphere contacting the surface), air or atmosphere movement (blowing), applying a vacuum to draw off the liquid as vapor, or a combination thereof.

The advantages of using treatment compositions of the present invention to treat surfaces will now be described in the illustrative context of using a resulting, treated containment to store flowable, solid polymer bodies. In preferred modes of practice, at least a portion of the surface(s) of the containment that contact the flowable solid polymer bodies as well as the flowable solid polymer bodies both are treated with treatment composition(s) of the present invention. While treated the surfaces of the containment may help to protect against fouling of the surfaces, treating both the containment and the flowable solid polymer bodies would provide even further protection against fouling as well as help make the flowable, solid polymer bodies more resistant to blocking with each other as well.

The method of using the treated containment may comprise disposing a plurality of flowable solid polymer bodies (treated or untreated, but preferably treated with a treatment composition of the present invention) into the interior volume defined by the containment. The flowable solid polymer bodies may be any of the flowable solid polymer bodies of the present invention as described hereinabove. As a result of the surface treatment of the containment, the stored flowable solid polymer bodies would show less of a tendency to foul or otherwise adhere to the containment surfaces. Consequently, the flowable, solid polymer bodies would be easier to dispense into the containment and easier to withdraw from the containment.

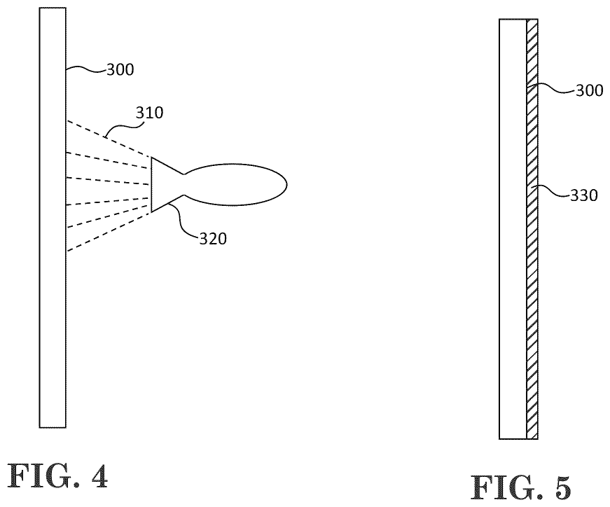

Exemplary embodiments of the method of treating a surface and then using the resultant treated surface will now be described in relation to FIG. 4 and FIG. 5, respectively. With reference to FIG. 4, an aqueous treatment composition of the present invention may be applied to surface 300 by any suitable application technique. For purposes of illustration, for example, spray 310 of the aqueous treatment composition is applied to surface 300 from nozzle 320. Surface 300 may be any surface that may come into contact with one or more flowable solid polymer bodies or the surface of a polymer body. While some previously known aqueous surfactant solutions, when sprayed or otherwise subject to shear or other agitating forces are often prone to undue foaming, advantageously, the aqueous treatment compositions of the invention could resist the formation of undue amounts of foam when sprayed. In other modes of practice, some degree of foaming may be desirable when spraying onto surfaces to be treated, as foamed material may be able to adhere better to the surfaces being treated rather than sheeting off before a desired degree of treatment results. Consequently, the application of spray 310 may occur under conditions effective to generate a foam that would adhere to the surface better than a less foamed or unfoamed embodiment. As an alternative, one or more optional additives can be incorporated into the treatment compositions in order to facilitate coating of the surface to be treated as opposed to applying spray material that unduly sheets off the surfaces too soon.

With reference to FIG. 4 and FIG. 5, surface 300 may be left to dry or otherwise caused to dry, such that water and any other volatile solvents (if present) evaporate and leave dried coating 330 as a surface treatment of the present invention on surface 300. Dried coating 330 may comprise the first nonionic surfactant, the second nonionic surfactant and one or more optional ingredients, if any.

Surface 300 may be any surface that may contact flowable polymer bodies as described herein. Non-limiting examples include surface(s) of containments, pelletizers, dryers, separators, distillation equipment, classifiers, heat exchangers, pumps, vanes, blades, conveyor surfaces, gauges, extruders, chutes, and the like. Non-limiting examples of containments include silos, pipes, railcars, tanks, classifiers, hoppers, bags, cartons, and the like.

### Examples

The following examples are intended to illustrate different aspects and embodiments of the invention and are not to be considered limiting the scope of the invention. It will be recognized that various modifications and changes may be made without departing from the scope of the claims.

### Example 1: Foam Screening Tests

Nonionic surfactant TERGITOL™ 15-S-7 (the substrate surfactant), an ethoxylate of a C12-C14 secondary alcohol, was dissolved in distilled water to make a 0.1 weight percent stock solution (one thousand parts by weight of the surfactant per one million parts of the solution). Separate aliquots of the 0.1 weight percent stock solution of TERGITOL™ were taken, and to each portion a different test material was added to make one thousand parts by weight of each test material in the aqueous combination of the TERGITOL and the test material. Accordingly, each bottle contained an aqueous mixture having 0.1 wt % (1000 ppm) TERGITOL 15-S-7 and 0.1 wt % (1000 ppm by weight) of a test material. Each bottle was shaken and the result assessed by eye to determine whether foaming occurred and how much. The results are shown in TABLE 1.

TABLE 1

| | 0.1 wt % | | |
|---|---|---|---|
| Trial | Surfactant | | Result on |
| Series | solution | Test material | shaking |
| 1 | TERGITOL ™ | High molecular weight | Extreme |
| | 15-S-7 | propylene oxide polymers | foaming |
| 2 | | Styrene-acrylonitrile copolymer | |
| | | particles embedded in polyols | |
| 3 | | Hydrophobic polyols | |
| 4 | | Ethoxylated propoxylated 2-ethyl- | |
| | | 1-hexanol (ECOSURF LFE1410) | |
| 5 | | Ethoxylated 2-propyl | |
| | | 1-heptanol-ethyl-1-hexanol | |
| | | (LUTENSOL XP30) | |
| 6 | | Polyether polyol | Moderate |
| | | (VORANOL P8000) | foaming |
| 7 | | Ethylene oxide/propylene oxide | Extreme |
| | | block copolymer comprising about | foaming |
| | | 20% by weight ethylene oxide | |
| | | (PLURONIC 25R2) | |
| 8 | | Saturated iso-C13 alcohol | |
| | | (LUTENSOL TO3) | |
| 9 | | C13-C15 oxo alcohol | |
| | | (LUTENSOL AO3) | |

TERGITOL™ 15-S-7 is C12-C14 ethoxylated secondary alcohol (100% actives) with an average of about 7 moles of ethylene oxide groups (—CH₂CH₂O) per molecule, and having an HLB of 12.1. TERGITOL 15-S-7 is available from Dow Chemical Company, Midland, Michigan, USA.

### Example 2: Foam Screening Tests

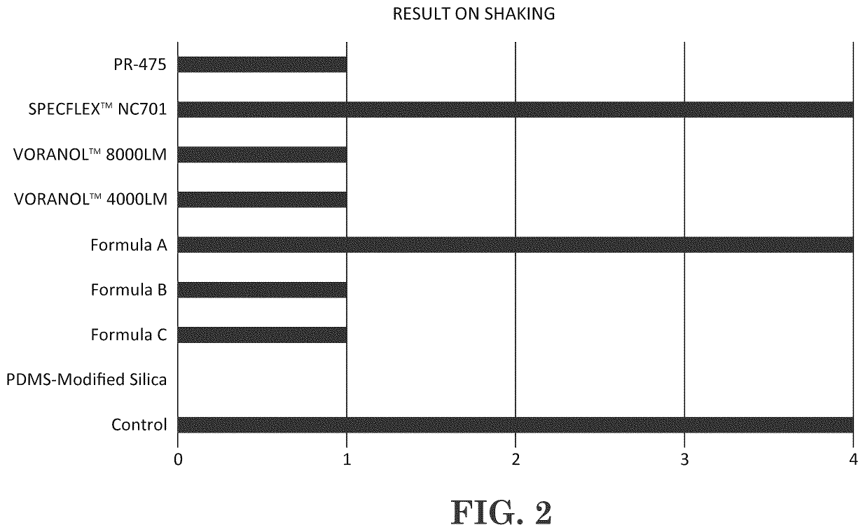

The experiment performed in Example 1 was repeated with further test materials. Each bottle contained an aqueous mixture including TERGITOL 15-S-7 at 0.1 wt % (1000 ppm by weight) and the test material at 0.1 wt % 1000 ppm. Each bottle was shaken and the relative height of foam was judged by eye. The results are given in TABLE 2 and represented visually in FIG. 2.

TABLE 2

| | 0.1 wt % | | |
|---|---|---|---|
| | Surfactant | | |
| Trial | solution | Test material | Result on |
| Series | (1,000 ppm) | (1,000 ppm) | shaking |
| 10 | TERGITOL | PEG diester | 1 |
| 11 | 15-S-7 | Specflex ™ NC 701 | 4 |
| 12 | | VORANOL ™ 8000LM | 1 |
| 13 | | VORANOL 4000LM | 1 |
| 14 | | Formula A | 4 |
| 15 | | Formula B | 1 |
| 16 | | Formula C | 1 |
| 17 | | PDMS-Modified Silica | 0 |
| 18 | | None | 4 |

Results on shaking: 0=no foam, 1=some foam, 4=foam height about four times or more the foam height represented by a score of 1.

PEG diester is a tall oil acid diester of a polyethylene glycol.

SPECFLEX™ NC 701 is a hydrophobic polyglycol available from Dow Chemical Company, Midland, Michigan, USA.

VORANOL™ 8000LM is available from Dow Chemical Company, Midland, MI, USA.

VORANOL 4000LM is a polypropylene glycol available from Dow Chemical Company, Midland, MI, USA.

Formula A is a composition comprising 60 wt % of SPECFLEX NC 701, 30 wt % of the PEG diester as described above, and 10 wt % of dipropylene glycol.

Formula B is a composition comprising 60 wt % of VORANOL™ 8000LM, 30 wt % of PR-475, and 10 wt % of dipropylene glycol.

Formula C is a composition comprising 60 wt % of a polypropylene glycol, 30 wt % of the PEG diester as described above, and 10 wt % dipropylene glycol.

PDMS-Modified Silica is a silica sol modified by reaction with a polydimethylsiloxane.

### Example 3: Foam Tests

1000 mL of a 0.1 wt % (1000 ppm by weight) aqueous stock solution of TERGITOL 15-S-7 was made. Aliquots of 100 mL each of the TERGITOL stock solution were disposed into a 1000 mL graduated cylinder, and to each aliquot a different test material was added (except for Trial 19) to make compositions as displayed in TABLE 3.

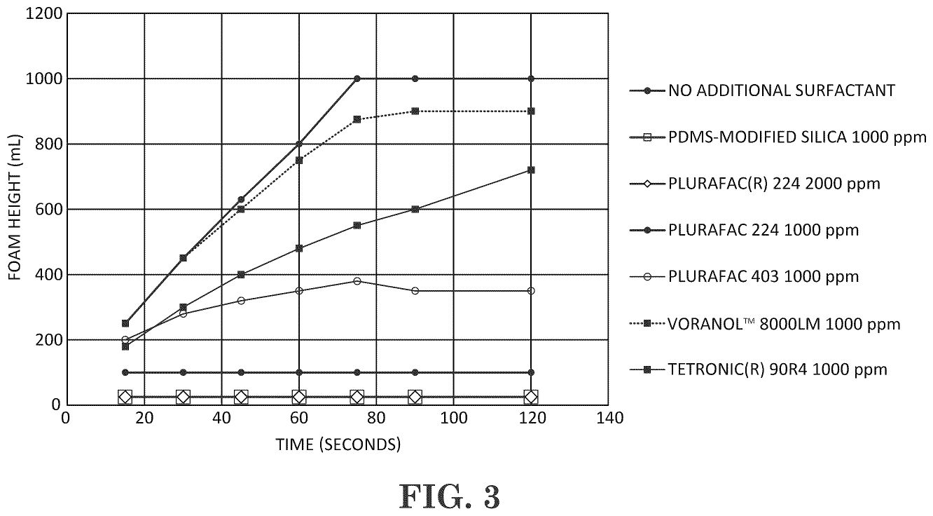

The antifoam efficiency of each composition was measured using a modified version of ASTM D892. Nitrogen gas was used for dispersion. Nitrogen gas was bubbled through the composition at a flow rate of 725 mL/minute of nitrogen, thereby dispersing the additional surfactant. The foam height in the cylinder was measured at 15, 30, 45, 60, 75, 90, and 120 seconds after nitrogen flow was started. The results are displayed in TABLE 3 and graphically in FIG. 3.

TABLE 3

| | Trial series | | | | | | |
|---|---|---|---|---|---|---|---|
| | 19 | 20 | 21 | 22 | 23 | 24 | 25 |
| | Surfactant | | | | | | |
| | TERGITOL 15-S-7 (1000 ppm by weight) | | | | | | |
| | Additional surfactant | | | | | | |
| | | Aqueous | | | | | |
| | | PDMS- | | | | | |
| | | modified | PLURAFAC ® | PLURAFAC | PLURAFAC | VORANOL ™ | TETRONIC ® |
| | | silica | 224 | 224 | 403 | P8000 | 90R4 |
| | None | (1000 ppm) | (2000 ppm) | (1000 ppm) | (1000 ppm) | (1000 ppm) | (1000 ppm) |
| | Foam | Foam | Foam | Foam | Foam | Foam | Foam |
| Time | height | height | height | height | height | height | height |
| (seconds) | (mL) | (mL) | (mL) | (mL) | (mL) | (mL) | (mL) |
| 15 | 250 | 25 | 25 | 100 | 200 | 250 | 180 |
| 30 | 450 | 25 | 25 | 100 | 280 | 450 | 300 |
| 45 | 630 | 25 | 25 | 100 | 320 | 600 | 400 |
| 60 | 800 | 25 | 25 | 100 | 350 | 750 | 480 |
| 75 | 1000 | 25 | 25 | 100 | 380 | 875 | 550 |
| 90 | 1000 | 25 | 25 | 100 | 350 | 900 | 600 |
| 120 | 1000 | 25 | 25 | 100 | 350 | 900 | 720 |

Aqueous PDMS-Modified Silica is a silica sol modified by reaction with polydimethylsiloxane.

PLURAFAC® 224 is an ethoxylated butoxylated alcohol, wherein the alcohol is a predominantly unbranched C10-C16 alcohol available from BASF, Ludwigshafen, Germany.

PLURAFAC® 403 is an ethoxylated propoxylated alcohol available from BASF, Ludwigshafen, Germany.

TETRONIC® 90R⁴ is a tetrafunctional block copolymer with terminal secondary hydroxyl group available from BASF, Ludwigshafen, Germany.

Referring to FIG. 3, the blank test, Trial 19 (Tergitol 15-S-7 with no additional surfactant) showed the most foaming. The trials showing least foaming were those in which the aqueous PDMS-modified silica (Trial 20) and PLURAFAC 224 at 2000 ppm (Trial 21) were the additional surfactants. Both trials showed excellent results. Accordingly, each of PDMS-modified silica (Trial 20) and PLURAFAC 224 at 2000 ppm (Trial 21) was most effective at mitigating foaming of the Tergitol 15-S-7.

### Example 4: Foam Tests and Order of Addition of Surfactants

1000 mL of a 0.1 wt % (1000 ppm by weight) aqueous stock solution of TERGITOL 15-S-7 was made. 1000 mL of a 0.1 wt % (1000 ppm by weight) aqueous PLURAFAC 224 was made. Two orders of addition were investigated.

### Mixing Outside

A 100 mL aliquot of the TERGITOL stock solution was combined with a 200 ML (microliters) of the aqueous PLURAFAC 224 and mixed. The mixture was then disposed into a 1000 mL graduated cylinder to make a first composition.

A second 100 mL aliquot of the TERGITOL stock solution was combined with a 100 ML (microliters) of the TERGITOL stock solution to make a second composition.

The antifoam efficiency of each of the first and second compositions was measured using a modified version of ASTM D892. Nitrogen gas was used for dispersion. Nitrogen gas was bubbled through the composition at a flow rate of 725 mL/minute of nitrogen. The foam height in the cylinder was measured at 15, 30, 45, 60, 75, 90, 105, and 120 seconds after nitrogen flow was started.

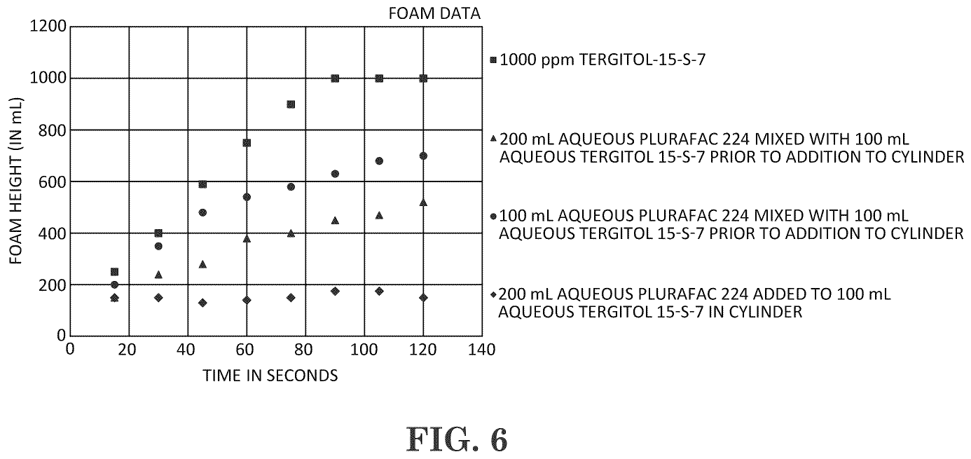

The results are displayed in FIG. 6.

### Mixing Inside

A 100 mL aliquot of the TERGITOL stock solution was transferred to a 1000 graduated cylinder. A 200 ML (microliters) of the aqueous PLURAFAC 224 was added to the aqueous TERGITOL in the graduated cylinder without mixing to make a combination.

After addition of the aqueous PLURAFAC 224 to the cylinder, the antifoam efficiency of the combination was measured using a modified version of ASTM D892. Nitrogen gas was used for dispersion. Nitrogen gas was bubbled through the combination at a flow rate of 725 mL/minute of nitrogen, thereby dispersing the additional surfactant. The foam height in the cylinder was measured at 15, 30, 45, 60, 75, 90, 105, and 120 seconds after nitrogen flow was started.

The results are displayed in FIG. 6.

As can be seen from FIG. 6, prior mixing of the two aqueous surfactants produced more foam than addition of the aqueous PLURAFAC 224 to the in-situ aqueous TERGITOL 15-S-7.

What is claimed is:

1. A method of treating a plurality of polymer pellets, the method comprising:
contacting the polymer pellets with an aqueous treatment composition, wherein the aqueous treatment composition comprises
i) an aqueous liquid carrier,
ii) a first nonionic surfactant comprising a plurality of ethylene oxide groups and a plurality of butylene oxide groups, and
iii) a second nonionic surfactant comprising a plurality of ethylene oxide groups, wherein the first and second nonionic surfactants are different from each other.

2. The method of claim 1, wherein the method further comprises drying the polymer pellets coated with at least a portion of the aqueous treatment composition to provide polymer pellets coated with at least a portion of the first nonionic surfactant and at least a portion of the second nonionic surfactant.

3. The method claim 1, wherein the first nonionic surfactant comprises an ethoxylated and butoxylated fatty alcohol.

4. The method of claim 3, wherein the first nonionic surfactant has the formula Bh—O-Ax-Y, wherein Bh is a hydrocarbyl group, O is an oxygen atom, Ax is an alkoxylate portion comprising the plurality of ethylene oxide groups and the plurality of butylene oxide groups, and Y is a monovalent moiety selected from hydrogen and hydrocarbyl.

5. The method of claim 4, wherein Bh is a C8-C18 alkyl group.

6. The method of claim 4 wherein Y is hydrogen and Bh is a C8-C18 alkyl group.

7. The method of claim 3, wherein the fatty alcohol is an unbranched C10-C16 fatty alcohol.

8. The method of claim 1, wherein the second nonionic surfactant comprises an ethoxylated alcohol.

9. The method of claim 8, wherein the ethoxylated alcohol has the formula Ch-O-(Ex)-Z, wherein Ch is a hydrocarbyl portion, Ex is an alkoxylate portion comprising ethylene oxide groups, O is oxygen, and Z is hydrogen, a hydrocarbyl group, or other monovalent entity.

10. The method of claim 9, wherein Ch is a C10-C16 alkyl group.

11. The method of claim 9, wherein Z is hydrogen.

12. The method of claim 8, wherein the ethoxylated alcohol is an ethoxylated fatty alcohol.

13. The method of claim 12, wherein the ethoxylated fatty alcohol is an ethoxylate of a secondary C10-C16 fatty alcohol.

14. The method of claim 1, wherein the aqueous treatment composition further comprises a polysiloxane.

15. The method of claim 1, wherein the aqueous treatment composition further comprises a polysiloxane-modified silica sol.

16. The method of claim 15, wherein the aqueous treatment composition comprises a polydimethylsiloxane-modified silica sol.

17. A method of treating a containment defining an interior volume, the method comprising contacting an interior surface of the containment with an aqueous treatment composition in a manner effective to provide a treated containment having a treated interior surface, wherein the aqueous treatment composition comprises
i) an aqueous liquid carrier;
ii) a first nonionic surfactant comprising a plurality of ethylene oxide groups and a plurality of butylene oxide groups; and
iii) a second nonionic surfactant comprising a plurality of ethylene oxide groups, wherein the first and second nonionic surfactants are different from each other.

18. A method of extruding a polymer, the method comprising:
(a) melt-extruding a polymer to form an extrudate; and
(b) contacting the extrudate with a cooling composition,
wherein the cooling composition comprises:
i) an aqueous liquid carrier,
ii) a first nonionic surfactant comprising a plurality of ethylene oxide groups and a plurality of butylene oxide groups, and
iii) a second nonionic surfactant comprising a plurality of ethylene oxide groups, wherein the first and second nonionic surfactants are different from each other.

19. A treatment composition comprising:
a) a first nonionic surfactant comprising a plurality of ethylene oxide groups and a plurality of butylene oxide groups; and
b) a second nonionic surfactant comprising a plurality of ethylene oxide groups, wherein the first and second nonionic surfactants are different from each other.

20. A plurality of treated polymer pellets, each of the polymer pellets including an outer surface, wherein the outer surface is at least partially coated with a treatment, the treatment comprising
a) a first nonionic surfactant comprising a plurality of ethylene oxide groups and a plurality of butylene oxide groups, and
b) a second nonionic surfactant comprising a plurality of ethylene oxide groups, wherein the first and second nonionic surfactants are different from each other.
